(19) United States
(12) Patent Application Publication
(10) Pub. No.: US 2007/0089690 A1
(43) Pub. Date: Apr. 26, 2007

(54) Pet steps

(76) Inventors: Ajit Khubani, Saddle River, NJ (US); Daniel M. Nosenchuck, Mercerville, NJ (US)

Correspondence Address: COOPER & DUNHAM, LLP, 1185 AVENUE OF THE AMERICAS, NEW YORK, NY, 10036, US

(21) Appl. No.: 11/255,729

(22) Filed: Oct. 21, 2005

(51) Int. Cl. A01K 1/035; A01K 29/00

(52) U.S. Cl. 119/847

(57) ABSTRACT

A pet step device for allowing pets to reach elevated locations having a pair of stair sides and at least one tread. The pet step device can also have at least one riser, at least one support, and/or a cover. In addition, one for more stair side extensions having at least one tread can be added to the stair sides. The pet step device can be formed by attaching the treads (and the risers, the stair side extensions, and support) to the stair sides and then placing a cover over the entire assembly to create a unitary structure.

### TECHNICAL FIELD

This invention relates generally to steps and more particularly to a lightweight step structure or stairs for use by domestic pets in reaching and leaving elevated places, such as beds and couches.

### BACKGROUND

Domestic pets, such as cats and dogs, like to and sometimes need to access elevated places, such as beds and couches. Pets typically jump or navigate across progressively higher furniture to reach a desired elevated destination. For some pets, especially older and physically impaired pets, such as those with joint problems, hip dysphasia and arthritis, jumping to and off elevated places can expose the pet to injury or can aggravate existing injuries.

Prior art pet steps tend to be bulky and/or heavy, making transport or storage cumbersome. Many prior art pet steps comprise individual steps stacked one on top of another. Other prior art pet steps comprise numerous parts that make manufacturing and shipping difficult and expensive. Some prior art pet steps require assembly but are often difficult to assemble or require additional materials or tools. Therefore, a need exists for lightweight yet sturdy pet steps that are inexpensive to manufacture and ship while also being easy to assemble.

### SUMMARY OF THE INVENTION

The present invention provides pet steps that are both sturdy and lightweight such that a pet may easily access elevated locations.

Also, the present invention provides pet steps that are simple and inexpensive to manufacture and ship.

Further, the present invention provides pet steps that are easy to assemble without the use of additional tools or materials.

In addition, the present invention provides a pet step device for allowing pets to reach elevated locations having an assembly having a pair of stair sides, and at least one tread attached to said stair sides. This pet step device can also have: (1) at least one riser attached to said stair sides; (2) at least one support attached to said stair sides; and/or (3) a cover for covering said assembly. Also, said stair sides can have one or more connectors and said at least one tread, said at least one riser, and/or said at least one support can have one or more mating connectors for connecting said tread, riser, and/or support to said stair sides. The connectors and mating connectors can be posts and corresponding holes.

Also, the present invention provides that the pet step device can have at least one pair of stair side extensions attached to said stair sides and at least one tread attached to said stair side extensions. Said side stair extensions can also have at least one riser and/or support attached to thereto. Further, the pet step device can have a cover for covering said assembly, including the stair side extensions.

In addition, the present invention provides that each tread, riser, stair side, and/or stair side extension can have one or more anti-slip devices, such as, but not limited to, nubs, loop fasteners, hook fasteners, and/or glue.

The present invention also provides a method of assembling a pet step device having the steps of: attaching at least one tread to a pair of stair sides to form a freestanding structure; and covering said freestanding structure with a cover. The method can also have the steps of attaching: (1) at least one riser to said freestanding structure; (2) at least one support to said freestanding structure; and/or (3) a pair of stair side extensions to said pair of stair sides.

Additionally, the present invention provides for pet steps having a pair of stair sides, at least one tread, at least one riser, at least one or more supports connecting the stair sides, and a cover. The pet steps are formed by attaching the tread, riser and support to the stair sides. The cover goes over the entire assembly to create a unitary structure.

Also, the present invention provides for pet steps having a pair of stair sides, at least one or more supports connecting the stair sides, at least one tread, at least one riser, at least one pair of stair side extensions, at least one or more supports connecting the stair side extensions, and a cover. The pet steps are formed by attaching the treads, risers, stair side extensions and supports to the stair sides. The cover goes over the entire assembly to create a unitary structure.

### BRIEF DESCRIPTION OF THE DRAWINGS

The features of the present invention can be more readily understood from the detailed description below with reference to the accompanying drawings herein.

FIG. 1 is an exploded perspective of pet steps in accordance with an embodiment of the present invention.

FIG. 2 is an exploded perspective of pet steps in accordance with an embodiment of the present invention.

FIG. 3 is a plan view of the underside of a tread or riser in accordance with an embodiment of the present invention.

FIG. 4 is a side view of a tread in accordance with an embodiment of the present invention.

FIG. 5 is a perspective view of a cover for enveloping pet steps in accordance with an embodiment of the present invention.

### DETAILED DESCRIPTION

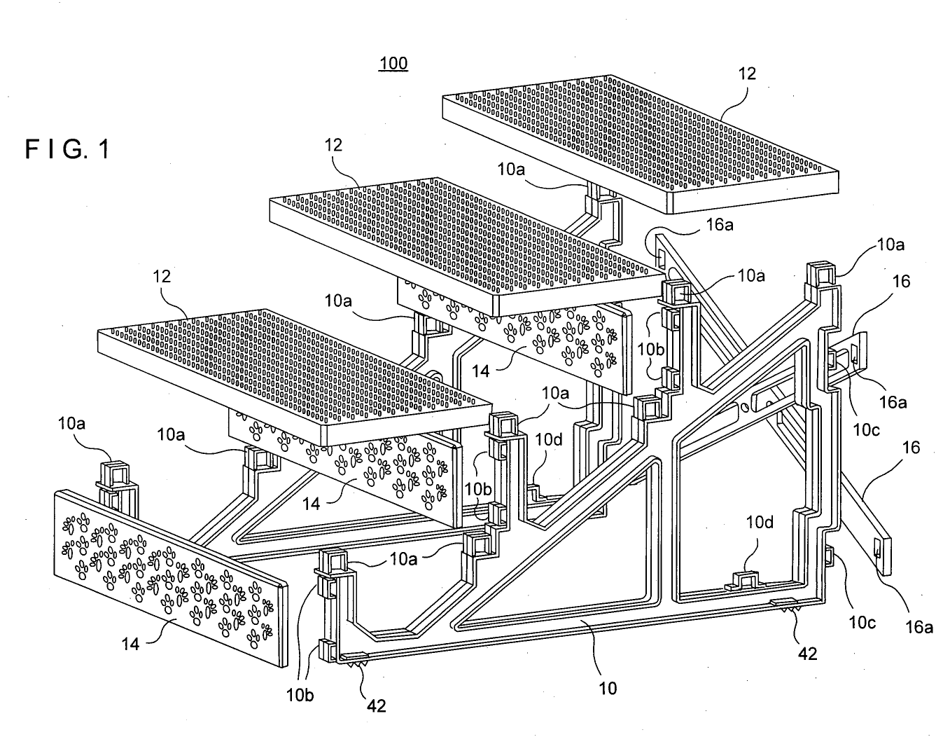

One embodiment of pet steps of the present invention, generally designated as 100, is shown in FIG. 1. Pet steps 100 has a pair of stair sides 10, at least one tread 12, at least one riser 14, at least one support 16, and a cover (see FIG. 5).

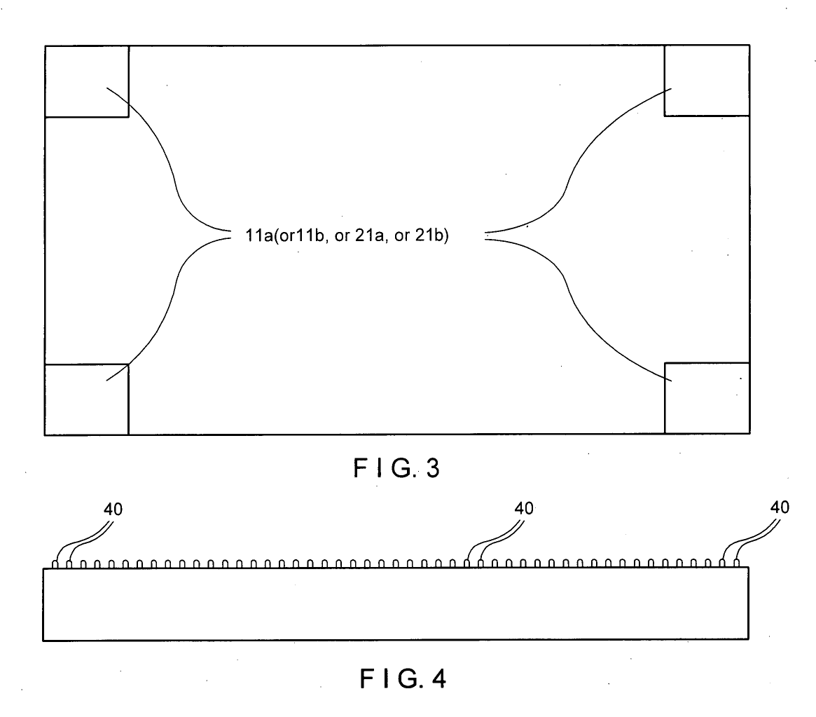

Each stair side 10 has one or more connectors 10a for the treads and one or more connectors 10b for the risers. According to the embodiment in FIG. 1, each stair side 10 has a pair of connectors for connecting one side of each respective tread and riser. Also in the embodiment, each connector is a rectangular male post. Each tread 12 has mating connectors 11a for the tread connectors 10a of the stair side 10 located on its underside. Similarly, each riser 14 further comprises mating connectors 11b located on its underside to receive the riser connectors 10b. In this embodiment, the tread and riser mating connectors are rectangular female holes for receiving the posts of tread connectors 10a and riser connectors 10b, respectively (see FIG. 3), and for holding the male posts in place by a locking mechanism, for example, friction between the posts and holes. By interlocking connectors 10a with mating connectors 11a on tread 12 and connectors 10b with mating connectors 11b on riser 14, tread 12 and riser 14 are secured to stair sides 10.

In this embodiment, each stair side 10 has one or more connectors 10c for support 16. The connectors are preferably rectangular male posts. Support 16 has mating connectors 16a, preferably rectangular female holes, to receive the posts of connectors 10c and to hold the male posts in place by a locking mechanism, for example, friction between the posts and holes. By interlocking support connectors 10c and mating connectors 16a, support 16 is secured to stair sides 10 and provides additional support to pet steps 100. Each stair side 10 further has one or more connectors 10d, which may be used to connect an additional support to the stair sides 10 (see below).

In one embodiment, the risers 14 and/or the support 16 can be omitted. Also in such an embodiment, the connectors 10b, 10c for the risers and/or support can be omitted from the stair sides 10 and/or extensions of the stair sides (see below).

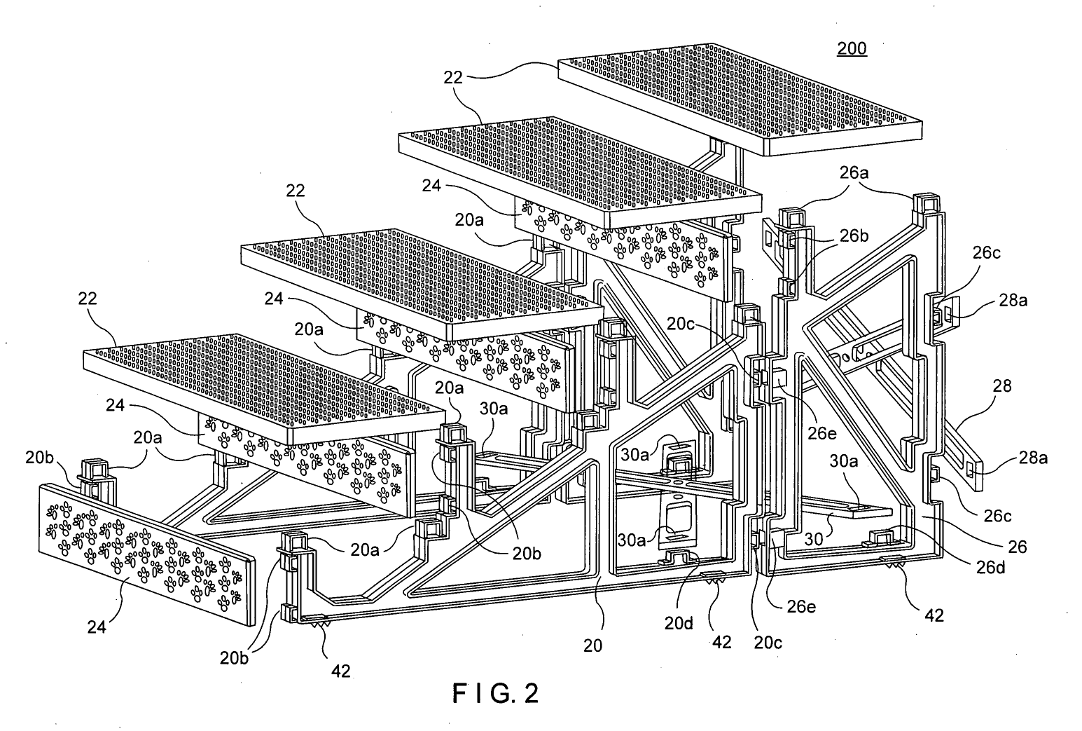

The embodiment of FIG. 1 can be augmented with additional steps. A four-step embodiment of pet steps of the present invention, generally designated as 200, is shown in FIG. 2. Pet steps 200 has a pair of stair sides 20, at least one tread 22, at least one riser 24, at least one pair of stair side extensions 26, a support 28, an additional support 30, and a cover (see FIG. 5).

Each stair side 20 has one or more connectors 20a for the treads and one or more connectors 20b for the risers. According to the embodiment in FIG. 2, each stair side 20 has a pair of connectors for connecting one side of each respective tread and riser. Also in the embodiment, each connector is a rectangular male post. Each tread 22 has mating connectors 21a for the tread connectors 20a of the stair side 20 located on its underside. Similarly, each riser 24 further comprises mating connectors 21b located on its underside to receive the riser connectors 20b. In this embodiment, the tread and riser mating connectors 21a and 21b are rectangular female holes for receiving the posts of tread connectors 20a and riser connectors 20b, respectively (see FIG. 3), and for holding the male posts in place by a locking mechanism, for example, friction between the posts and holes. By interlocking connectors 20a with mating connectors on tread 22 and connectors 20b with mating connectors on riser 24, tread 22 and riser 24 are secured to stair sides 20.

Each stair side 20 has one or more connectors 20c for a stair side extension 26. In this embodiment, connectors 20c are rectangular male posts. Stair side extensions 26 have such a height above the height of stair sides 20 as to accommodate an additional step for pet steps 200. Each stair side extension 26 has one or more mating connectors 26e. In this embodiment, mating connectors 26e are rectangular female holes for receiving the posts of connectors 20c and for holding the male posts in place by a locking mechanism, for example, friction between the posts and holes. By interlocking connectors 20c with mating connectors 26e, stair side extensions 26 are secured to stair sides 20.

Each stair side extension 26 has one or more connectors 26a for a tread and one or more connectors 26b for a riser. In this embodiment, connectors 26a and 26b are rectangular male posts. By interlocking connectors 26a with mating connectors 21a on tread 22 and connectors 26b with mating connectors 21b on riser 24, tread 22 and riser 24 are secured to stair side extensions 26.

Each stair side extension 26 has one or more connectors 26c for support 28. In this embodiment, connectors 26c are rectangular male posts. Support 28 has one or more mating connectors 28a. In this embodiment, mating connectors 28a are rectangular female holes for receiving the posts of connectors 26c and for holding the male posts in place by a locking mechanism, for example, friction. between the posts and holes. By interlocking connectors 26c and mating connectors 28a, support 28 is secured to stair side extensions 26 and provides additional support to pet steps 200. Alternatively, additional stair side extensions of greater height than stair side extensions 26 such as to accommodate an additional step may be attached to stair side extensions 26 instead of support 28. Additional stair side extensions may be added as many times as desired with support 28 attached to the final added stair side extensions in order to provide support to the final assembly.

Each stair side 20 further has one or more connectors 20d for additional support 30. Each stair side extension 26 has one or more connectors 26d for additional support 30. In this embodiment, connectors 20d and 26d are rectangular male posts. Support 30 has one or more mating connectors 30a. In this embodiment, mating connectors 30a are rectangular female holes for receiving the posts of connectors 20d and 26d. By interlocking connectors 20d and 26d with mating connectors 30a, support 30 is secured to both stair sides 20 and stair side extensions 26 such that additional support is provided to pet steps 200. If additional stair side extensions are added to accommodate additional steps, multiple supports may be utilized in the same manner as additional support 30 to provide added stability to the present invention.

The connectors described in the above embodiments are preferably rectangular, but other shapes, for example squares, circles and/or triangles, may be utilized to connect the treads, risers, stair side extensions, and supports to the stair sides. Alternatively, in lieu of the connectors thus far contemplated, adhering devices and/or materials, for example loop and hook fasteners or glue, may be used to connect the treads, risers, stair side extensions, and supports to the stair sides in order to form the pet steps of the present invention.

Although the above embodiments describe the use of a pair of connectors to connect one side of each respective tread and riser to the stair sides, any number of connectors may be employed to connect the treads and risers to the stair sides. Similarly, any number of connectors may be used to connect the stair side extensions to the stair sides as well as to connect the supports to the stair sides or the stair side extensions. The supports in the above embodiments are preferably two cross beams held together by a fastener. Any known configuration for supporting the pet steps, however, may be utilized in lieu of the support member described above so long as enough support is provided to stabilize the pet steps of the present invention such that a pet can safely reach an elevated location.

Pet steps 100 and 200 can be made of any material but preferably a lightweight material, for example wood, plastic such as polypropylene, fiberglass, or metal.

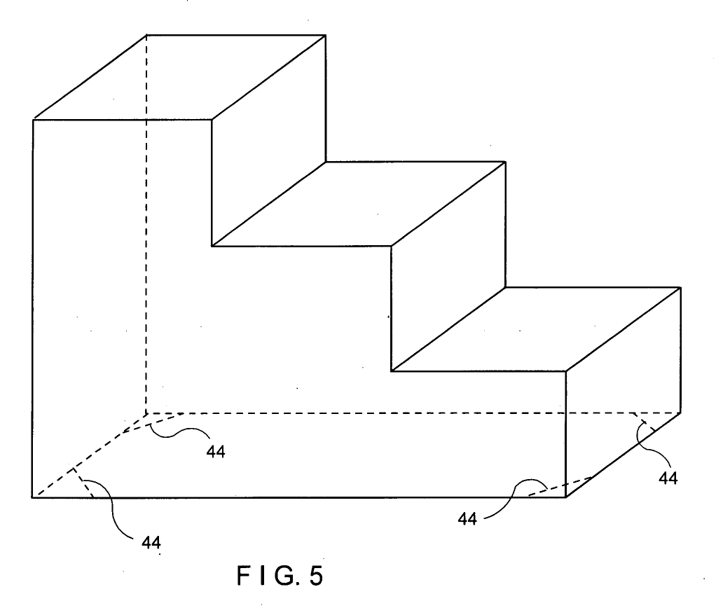

A cover, shown in FIG. 5, can be used to envelop pet steps 100 and 200. The cover is preferably a single piece made out of one or more reusable and durable materials, for example natural fiber, nylon or acrylic fabric. The cover preferably has a stretchable opening capable of accepting pet steps 100 or 200. The dimensions of the cover and the opening are dependent on the size of pet steps 100 and 200. The cover should fit as snugly as possible with pet step 100 and 200 such that there is no excess or overhang on which a pet may get caught in or trip over. The surfaces of tread 12 and tread 22 are preferably made to grab the cover and prevent slippage of the cover such that the cover will not slip when a pet walks on the surface of the treads. FIG. 4 illustrates one embodiment in which a tread has small nubs 40 to grab the cover. The cover may be made out of different materials or reinforced with additional materials at locations where the cover covers the treads. Alternatively, the cover may be made out of carpet at locations where the cover covers the treads. The carpet can be anchored or held in place by the nubs 40 on the treads or by other anti-slip devices and/or materials, for example loop and hook fasteners, or glue. The cover may come in a variety of colors, patterns and textures to accommodate the preferences of the pet or its owner.

In one embodiment, the cover is further held in place by plastic or elastic bands 44 drawing the bottom opening of the cover underneath the base of the pet steps. Downward facing nubs 42 or other non-slip mechanism on the stair sides 10, 20 can prevent slippage of pet steps 100, 200 across a floor.

The present invention is easy to assembly without the use of additional tools or adhesive materials. A single tread and a single riser can be simply pressed to attach onto the stair sides to create a freestanding structure. Additional treads and risers can then be added onto the freestanding structure along with stair side extensions and supports to form the pet steps assembly of the present invention.

Although descriptions have been provided above for three-step and four-step embodiments of the present invention, it should be appreciated by one skilled in the art that the number of steps is not limited by the above descriptions. Stair side extensions and accompanying treads and risers may be added to increase or removed to decrease the height of the present invention to accommodate various locations.

In describing exemplary embodiments, specific terminology is employed for the sake of clarity in this disclosure. The disclosure of this patent specification, however, is not intended to be limited to the specific terminology so selected and it is to be understood that each specific element includes all technical equivalents that operate in a similar manner.

In addition, the above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A pet step device for allowing pets to reach elevated locations comprising:
an assembly comprising a pair of stair sides; and at least one tread attached to said stair sides.

2. The pet step device of claim 1 wherein said assembly further comprises at least one riser attached to said stair sides.

3. The pet step device of claim 1 wherein said assembly further comprises at least one support attached to said stair sides.

4. The pet step device of claim 1 further comprising:
a cover for covering said assembly.

5. The pet step device of claim 1 wherein:
said stair sides have one or more connectors; and
said at least one tread has one or more mating connectors for connecting said tread to said stair sides.

6. The pet step device of claim 2 wherein:
said stair sides have one or more connectors; and
said at least one riser has one or more mating connectors for connecting said riser to said stair sides.

7. The pet step device of claim 3 wherein:
said stair sides have one or more connectors; and
said at least one support has one or more mating connectors for connecting said support to said stair sides.

8. The pet step device of claim 5 wherein said connectors are posts and said mating connectors are holes.

9. The pet step device of claim 1 wherein said assembly further comprises:
at least one pair of stair side extensions attached to said stair sides; and
at least one tread attached to said stair side extensions.

10. The pet step device of claim 9 wherein said assembly further comprises:
at least one riser attached to said stair side extensions.

11. The pet step device of claim 9 wherein said assembly further comprises:
at least one support attached to both said stair sides and said stair side extensions.

12. The pet step device of claim 9 further comprising a cover for covering said assembly.

13. The pet step device of claim 1 wherein each tread further comprises one or more anti-slip devices.

14. The pet step device of claim 13 wherein said anti-slip devices are selected from the group consisting of nubs, loop fasteners, hook fasteners, and glue.

15. A method of assembling a pet step device comprising the steps of:
attaching at least one tread to a pair of stair sides to form a freestanding structure; and
covering said freestanding structure with a cover.

16. The method of claim 15 further comprising the step of:
attaching at least one riser to said freestanding structure.

17. The method of claim 15 further comprising the step of:
attaching at least one support to said freestanding structure.

18. A method of assembling a pet step device according to claim 15 further comprising the step of:
attaching a pair of stair side extensions to said pair of stair sides.
